(19) United States
(12) Patent Application Publication
(10) Pub. No.: US 2023/0005453 A1
(43) Pub. Date: Jan. 5, 2023

(54) DISPLAY DEVICE WITH PIXEL GROUP ADDRESSING

(71) Applicant: COMMISSARIAT A L'ENERGIE ATOMIQUE ET AUX ENERGIES ALTERNATIVES, Paris (FR)

(72) Inventor: Jean-François MAINGUET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/664,684

(22) Filed: May 24, 2022

(30) Foreign Application Priority Data
May 26, 2021 (FR) 21 05468

(51) Int. Cl. G09G 5/36; G09G 3/32

(52) U.S. Cl. CPC G09G 5/36; G09G 3/32; G09G 2370/08; G09G 2310/0286; G09G 2360/145

(57) ABSTRACT

Display device including:
a pixel matrix comprising a plurality of pixel groups, each group comprising a plurality of pixel blocks;
a video card comprising an input configured to receive a digital signal to be displayed, and a plurality of outputs each coupled to a group by an associated primary data distribution network, the video card being configured to decode the digital signal and send to each of the outputs of digital data encoded in a format suitable for the matrix and intended to be displayed by the group coupled to said output;
and wherein:
each group includes a plurality of control circuits each associated with a block of the group and coupled to the associated main data bus;
each pixel includes a driver circuit configured to generate pixel control signals.

### TECHNICAL FIELD

This document relates to the field of pixel matrix display devices, and applies advantageously to the production of screens with large dimensions.

### PRIOR ART

Generally, a display device such as a television screen or a computer monitor receives a video signal through a video cable, for example an HDMI cable. The video signal corresponds to a digital signal encoding, without compression, light values to be displayed by each pixel of the device (generally at least three values for each pixel, i.e. one for each colour in the case of RGB pixels). This video signal is calculated by a graphics card for example.

The video signal received by the display device is in practice received by a video card which performs various data decoding, conversion and distribution operations to a pixel matrix of the display device. The video card can perform all or part of a digital-to-analogue conversion of data intended for the pixel matrix. In most cases where the digital-to-analogue conversion is performed in the video card, the latter outputs analogue values that can be displayed by the pixel matrix. In the event that the video card sends digital values to the pixels, the video card has to ensure the generation of a set of pixel control signals for controlling the display time of each pixel, for example with PWM (pulse width modulation) or BCM (binary code modulation) control signals. In these examples of pixel control signals, there is no digital-to-analogue conversion as each pixel is controlled in an “on/off” manner, in other words “transmits/does not transmit”.

Each pixel of the display device generally comprises a plurality of light elements for displaying a pixel of each image to be displayed by the device. A pixel generally includes at least three intensity-modulated light elements, each dedicated to one of the colours red, green and blue. Each light element can include either a light emitter modulated in intensity directly in the target colour of this element (in the case of OLED) or composed of a blue light source which is filtered and/or has added phosphors to obtain the target colour (in the case of other types of LED), or a light modulator (in the case of liquid crystals) coupled to an adequately coloured filter to obtain the target colour from a white light emitted by a source common to the pixels.

The analogue values obtained after digital-to-analogue conversion or the emission times for each pixel are proportional to the intensity of the light levels to be displayed by each of the light elements of the pixels. Each light element can be coupled to a selection transistor for controlling the display of the light signal by the light element. The display device also includes row drivers for controlling the selection transistors, column drivers supplying the pixels with values corresponding to the data to be displayed.

The increase in the resolution of display devices results in an increase in the number of rows and columns of the pixel matrix of the device (7680 columns and 4320 rows in the 8K format), which results in the multiplication of the number of electronic chips (forming in particular the row and column drivers) around the pixel matrix, as well as the number of wires needed to address the light elements of the pixels.

Moreover, in the case of a device for displaying videos or 3D images, i.e. a multiscope display, the number of items of information sent for each pixel is even greater given the multitude of points of view of the image to be displayed by the device, which requires a multiplication of the number of light elements per pixel, and therefore a larger number of wires are needed to address the light elements of the pixels. The energy required for the light elements and which is to be transmitted to the pixels is also significant.

### PRESENTATION OF THE INVENTION

Therefore there is a need to propose a display device with an architecture that reduces the complexity of the cabling and the number of wires necessary for addressing the light elements of the pixels of the display device.

To achieve this one embodiment proposes a display device including at least:
a pixel matrix comprising a plurality of groups of pixels, each group of pixels comprising a plurality of pixel blocks each including a plurality of pixels distributed over a plurality of neighbouring, or consecutive or adjacent, rows of pixels, and over a plurality of neighbouring, or consecutive or adjacent, columns of pixels, and each pixel comprising at least one light element;
a video card comprising at least one input configured to receive a digital signal to be displayed by the pixel matrix, and a plurality of outputs each coupled to a group of pixels by an associated primary data distribution network or bus, the video card being configured to decode the digital signal and send to each of the outputs digital data encoded in a format suitable for the pixel matrix and intended for display by the group of pixels coupled to said output;

and wherein:
each group of pixels includes a plurality of control circuits each associated with a pixel block of the pixel group and coupled to the associated primary data distribution network, each control circuit including a primary memory circuit configured to store a portion of the digital data for display by the associated pixel block and being configured to send to the associated pixel block, via an associated secondary data distribution network, said portion of digital data intended to be displayed by the associated pixel block;
each pixel includes at least one driver circuit configured to generate control signals for the one or more light elements of the pixel from digital data to be displayed by the one or more light elements of the pixel.

This display device proposes replacing the traditional row/column addressing by addressing with pixel groups themselves divided into blocks of pixels. This is made possible by the use of electronic circuits within the pixel matrix, namely control circuits associated with the pixel blocks and driving circuits configured to generate the control signals of the light element(s) of the pixel formed within each pixel. Due to this configuration making it possible to group together certain operations performed previously (in the prior art) outside the pixel matrix, the cabling needed to address the light elements of the pixels is simplified and requires fewer wires, the electronic chips at the periphery are eliminated and the cabling of the rows or columns can disappear, which makes this configuration particularly advantageous for obtaining screens with large dimensions.

Furthermore, with such a device, it is possible to address the different groups of pixels in parallel, which makes it possible to avoid having to successively address each row of pixels of the matrix.

A major difference between a conventional display device and the present display device is that the data sent to the pixels are digital here, and the generation of control signals for the light elements of the pixels is carried out within each pixel.

The division of the matrix into groups of pixels and the formation of certain functions within the pixel matrix makes it possible to limit the rate of data to be sent to the pixels, thus making these transfers easier to carry out.

The video card, which can also be referred to as a driver card, of the display device can receive the digital data from outside the display device for example via a cable such as an HDMI cable. The video card does not correspond to a graphics card which is for defining and sending the complete digital image data to the display device.

The video card corresponds to an electronic card including one or more integrated circuits and which is dedicated to driving the pixel matrix. The video card performs various data decoding, conversion and distribution operations for the pixel matrix on the basis of the digital signal received as input. In the display device here described, the video card does not perform the digital-to-analogue conversion of the data intended for the pixel matrix. The video card may ensure the generation of a set of pixel control signals to control the digital-to-analogue transformation in the pixels, for example with PWM (pulse width modulation) or BCM (binary coded modulation) control signals. In addition, the video card may only include digital integrated circuits, which makes it easier to implement.

The video card is configured to decode the received digital signal, then re-encode the digital data obtained in a format adapted to the pixel matrix, i.e. for the digital data intended for each group of pixels, in a format suitable for the control circuits, the type of pixels and the elements used for the distribution of data in the group of pixels.

The control signals of the light elements of the pixels control each of the light elements of the pixels, the display of a certain brightness value during a display reference period corresponding to duration of the display of an image by the pixel matrix.

A data distribution network comprises at least electrical connections, preferably shared, between a transmitter circuit and a plurality of receiver circuits. This definition applies to both primary and secondary data distribution networks.

Each primary data distribution network is used for the distribution of data from one of the outputs of the video card to the control circuits of the group of pixels coupled to said video card output.

Each secondary data distribution network is used for the distribution of data from one of the control circuits to the pixels of the pixel block associated with said control circuit.

In the present application, a pixel block corresponds to a group of adjacent pixels, each block including a plurality of pixels distributed over a plurality of neighbouring, or adjacent, rows of pixels and a plurality of neighbouring, or adjacent, columns of pixels. Thus, each pixel block forms, within each group of pixels, a “sub-matrix” with a minimum dimension of 2×2 pixels (but may have larger dimensions).

In an advantageous manner, each pixel may correspond to a module distinct from other pixels and may be transferred onto a pixel matrix support on which all or part of the primary data distribution networks and control circuits are located. Such pixels are very advantageous because they are particularly suitable for making screens of large dimensions which for cost reasons requires the use of a support which is not a semiconductor wafer. The formation of pixels in the form of such modules also makes it possible to have more space for electric power supply rows of pixels due to the available support surface between the modules, which makes it possible to reduce the access resistance. This configuration also makes it possible to consider the formation of conductive rows of the device in a single level.

In a particular configuration, the display device may be such that each control circuit includes at least one data receiving circuit configured to identify on the associated primary data distribution network the portion of digital data intended to be displayed by the pixel block with which the control circuit is associated, for example by means of an address associated with the data receiving circuit on the associated primary data distribution network comprising a data bus.

In this particular configuration, in each group of pixels, the routing of different portions of digital data in the different pixel blocks may be achieved by addressing on the primary data distribution network. This configuration may be used regardless of the size of the digital data portions, i.e. regardless of the amount of digital data intended for each block of pixels, whether or not this size is constant from one pixel block to the other of the group of pixels. In each control circuit, once identified by the data receiving circuit, the portion of digital data intended to be displayed by the pixel block to which the control circuit is associated may be stored in the primary memory circuit of the control circuit. In each control circuit, an output of data from the data receiving circuit may be coupled to an input of the primary memory circuit so that the data receiving circuit can transfer this data to the primary memory circuit.

In another particular configuration, in each group of pixels, the control circuits may include primary shift registers coupled in series from one control circuit to the other and distinct from the primary memory circuits, the primary shift register of a control circuit being configured to receive, over the primary data distribution network, the portion of digital data intended to be displayed by the pixel block with which the control circuit is associated. Such a configuration may be used when the size of the sub-portions of the digital data is constant for each group of pixels. In each control circuit, a data output of the primary shift register may be coupled to a data input of the primary memory circuit so that the primary shift register can transfer this data to the primary memory circuit.

Each pixel may further include a secondary memory circuit coupled to the secondary data distribution network, the secondary memory circuit able to be configured to store digital data to be displayed by the light element(s) of the pixel, the pixel driver circuit comprising an input coupled to an output of the secondary memory circuit of the pixel and at least one output coupled to the light element(s) of the pixel.

According to a first embodiment, in each block of pixels, the secondary memory circuits may include secondary shift registers coupled in series from one pixel to another and configured to pass the digital data intended to be displayed by the pixels of a same block from one pixel to the other. This configuration has the advantage of being simple to achieve and inexpensive given the small number of transistors required for the shift registers, and therefore the small semi-conductor surfaces necessary to obtain the shift registers. This configuration is used when the number of bits to be transmitted to each pixel of the same block is identical. This configuration also makes it possible to form all of the pixels in an identical manner without a specific address.

In this first embodiment, in each pixel, each secondary memory circuit may further include a latch comprising at least one input coupled to an output of the secondary shift register of the secondary memory circuit, and at least one output coupled to the input of the driver circuit of the pixel.

In a second embodiment, the display device may be such that:
each pixel includes at least one secondary address decoding circuit coupled to the associated secondary data distribution network, the secondary address decoding circuit being able to identify digital data intended to be displayed by the pixel;
each pixel block includes at least one secondary data connection of the data bus type to which at least one input of the secondary address decoding circuit of each pixel of the pixel block is coupled.

In this second embodiment, each secondary memory circuit may include:
at least one register comprising at least one input coupled to an output of the secondary address decoding circuit of the pixel comprising the secondary memory circuit, and
at least one latch comprising at least one input coupled to an output of the register of the secondary memory circuit, an output of the latch being coupled to an input of the driver circuit of the pixel comprising the secondary memory circuit.

The device may further include voltage reduction circuits configured to electrically power the pixels.

The driver circuits may include PWM or BCM modulators or digital-to-analogue converters.

Each group of pixels may form a plurality of complete rows of the pixel matrix.

Each control circuit may be formed by a chip separate from the pixels of the pixel block with which the control circuit is associated (which has the advantage that all of the pixels can be identical), or each control circuit may be integrated into one of the pixels of the pixel block with which the control circuit is associated, which reduces the number of chips to be carried on the support (all pixels other than those integrating the control circuits may be identical).

The video card and/or the control circuits and/or the pixels may include at least one digital data processing circuit.

At least a portion of the pixels may each include at least one photodetector coupled to an analogue-digital converter.

In this case, and when the display device is implemented according to the first embodiment:
in each pixel, at least one output of the analogue-to-digital converter may be coupled to an input of the shift register of the pixel (i.e. the one for receiving digital data to be displayed by the pixel);
in each block of pixels, an output of the shift register of one of the pixels in the pixel block may be coupled electrically to an input of the control circuit associated with the pixel block.

Throughout the text of this application, the term “coupled” may refer either to a direct connection between two elements, with no intermediate element between them, or to an indirect connection between these two elements, i.e. a connection formed through at least one intermediate element.

### BRIEF DESCRIPTION OF THE DRAWINGS

The present invention is explained further by reading the description of embodiments, which are given purely by way of example and with no limitations, with reference to the accompanying drawings in which:

FIG. 1 schematically shows a display device according to a first embodiment;

FIG. 2 schematically shows a portion of a display device according to the first embodiment;

FIGS. 3A and 3B show two embodiments of a series connection link between the pixels of a pixel block of a display device;

FIG. 4 shows an example of power and ground rows within a pixel block of a display device;

FIG. 5 schematically shows another embodiment of a display device;

FIG. 6 schematically shows an embodiment of the pixels of a display device;

FIGS. 7 and 8 schematically show a pixel of a display device according to variants of the first embodiment;

FIG. 9 schematically shows a pixel of a display device according to a second embodiment;

FIG. 10 schematically shows a portion of a display device according to an embodiment variant;

FIG. 11 schematically shows a pixel of a display device according to an embodiment variant;

FIG. 12 schematically shows a portion of a display device according to an embodiment variant;

FIG. 13 schematically shows a portion of a display device according to an embodiment variant;

FIG. 14 shows an embodiment variant of the display device;

FIG. 15 shows an example of power and ground rows within a pixel block of a display device, the pixel block including a voltage regulator circuit.

Identical, similar or equivalent portions of the various figures described in the following bear the same reference numerals so as to facilitate the passage from one figure to the other.

The different parts shown in the figures are not necessarily represented according to a uniform scale to make the figures more legible.

It should be understood that the various possibilities (variants and embodiments) are not exclusive of one another and can be combined with one another.

### DETAILED PRESENTATION OF PARTICULAR EMBODIMENTS

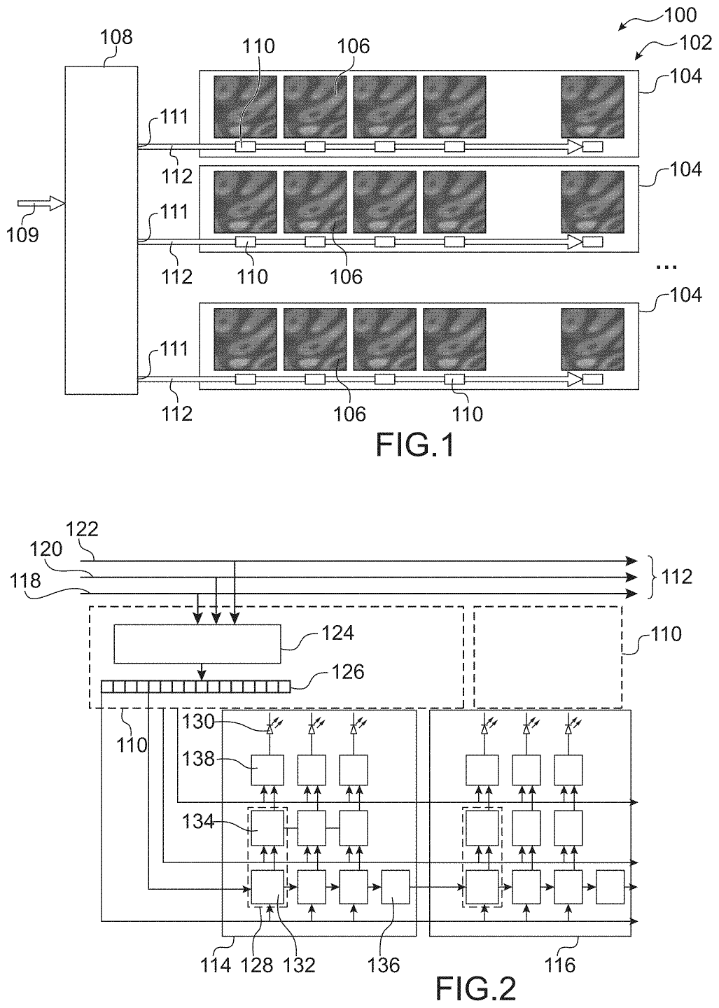

A display device 100 according to a first embodiment is described below in connection with FIG. 1.

The device 100 includes a pixel matrix 102. Each pixel of the matrix 102 includes one or more distinct light elements. The light elements of the pixels correspond for example to LEDs (or microLEDs) or OLEDs.

In addition to this or these light elements, each pixel of the device 100 also includes at least one secondary memory circuit configured to store digital data intended to be displayed by the light element(s) of the pixel, and at least one driver circuit configured to generate control signals of the light element(s) of the pixel from digital data intended to be displayed by the light element(s) of the pixel.

The integration of these electronic circuits, for example made by CMOS technology, within the pixels with the light elements may be performed as described in documents EP 3 381 060 A1 and “A New Approach for Fabricating High-Performance MicroLED Displays” by F. Templier et al., SID Symposium Digest of Technical Papers, Volume 50 (1), Jun. 1, 2019. For example, the LED corresponding to the light elements and the electronic circuits of the pixels may be made on different substrates, then cut out, assembled and finally transferred to a support, corresponding for example to one or more printed circuits, also intended to be used as a support for the other elements of the device 100.

FIG. 6 shows schematically the implementation of such an integration of the pixels. In the example of this figure, the light elements intended to each emit the colours red, green and blue are produced on different semiconductor wafers, referenced 103a, 103b and 103c, for each of these colours. The electronic circuits (here the secondary memory circuits and the driver circuits) are made by CMOS technology on another semi-conductor wafer 103d. The light elements made on the wafers 103a, 103b and 103c are cut out and then assembled on the wafer 103d. The pixels obtained are cut into independent modules 105. Alternatively, the light elements may be made on a single wafer, and the emission of different colours by these light elements is achieved by adding phosphors to the light elements intended to emit a red or green light colour. In this case, the wafer on which the light elements are formed may be attached to the wafer 103d without previously cutting out the light elements.

Each module 105 forms a pixel comprising the different light elements of the pixel (however it is possible that each module 105 includes a single light element) arranged on a CMOS portion in which the electronic circuits of the pixel are formed. These modules 105 are then transferred to the support, marked 107 in FIG. 6, of the matrix 102, at a desired distance from one another.

Thus, each module 105 forms a compact assembly of one or more electronic chips (advantageously obtained according to processes for manufacturing microelectronic components), provided with a connecting face having connecting pads intended to be fixed and connected electrically to corresponding connecting pads on the transfer pad. Thus, each module 105 comprises a monolithic chip or an assembly of a plurality of monolithic chips connected electrically, and a plurality of modules, for example identical or similar, are mounted on a single transfer substrate, each module corresponding for example to a pixel of the display device. For example, the elementary modules of the described display devices each include a plurality of LEDs and a transistor-based driver circuit, and may be manufactured according to identical or similar processes as described in patent application WO2017089676.

Each pixel of the matrix 102 is intended to display one pixel of the image or each image to be displayed by the device 100. In the embodiment described here, each pixel of the matrix 102 includes three distinct light elements, each intended to emit a light signal of one of the colours red, green or blue. Alternatively, each pixel of the matrix 102 may include more than three distinct light elements, such as for example when the device 100 is a multiscopic device intended to display simultaneously an image according to a plurality of viewpoints (with the aim of displaying this image in 3D), with for example in this case each pixel of the matrix 102 which includes as many sets of three distinct light elements as there are viewpoints of the image to be displayed. Alternatively, each pixel of the matrix 102 may include a single light element, for example when the device 100 corresponds to a monochrome screen.

The matrix 102 is divided into a plurality of pixel groups 104. Each group 104 is itself divided into a plurality of pixel blocks 106. In the embodiment described here, the matrix 102 is divided into 135 pixel groups 104, each of these pixel groups 104 including 240 pixel blocks 106. Furthermore, in this example, the groups 104 are arranged in rows, and the blocks 106 correspond to blocks of 8×8 pixels. Other sizes of pixel block 106 are possible: 16×16 pixels, 32×32 pixels, etc. More generally, each pixel block 106 corresponds to a submatrix of pixels of at least 2×2 pixels, i.e. comprising pixels arranged in at least two consecutive rows of pixels and in at least two consecutive columns of pixels.

For example, considering that the device 100 corresponds to a 75 inch screen, and that the pixel pitch, i.e. the distance between the centres of two neighbouring pixels, is for example equal to 865 μm, each pixel block 106 has dimensions equal to 55.36×55.36 mm², each group of pixels 104 has dimensions equal to 55.36×1660 mm², and the pixel matrix 102 has dimensions equal to 1.66×0.93 m².

Also by way of example, the device 100 may correspond to a screen with a so-called “full HD” resolution of 1920×1080 pixels, configured to achieve a display of 100 images/s. This device 100 may be configured to display digital data with an image coding of 24 bits, or 3 bytes, per pixel, i.e. one byte for each RGB colour to be displayed by each pixel. In this case, the minimum throughput of data received at the input of the device 100 is equal to 4.98 Gbits/s. By considering the distribution into pixel groups 104 and pixel blocks 106 as indicated above, the minimal throughput of digital data sent to each pixel group 104 from the video card 108 is 36.9 Mbit/s.

The device 100 may correspond to screen with any other resolution, and for example a resolution corresponding to a 4K or 8K format.

The device 100 includes a video card 108 comprising an input 109 configured to receive a digital signal corresponding to the images, or to the video, intended to be displayed by the pixel matrix 102. The input 109 is for example of the HDMI type. The video card 108 may further include a memory (not shown in FIG. 1) for storing data corresponding to one or more images to be displayed by the device 100. The video card 108 includes a plurality of outputs 111 each coupled to a group of pixels 104. The video card 108 is configured to decode the digital signal received as an input and to send to each of the outputs 111 digital data that is encoded in a format suitable for the pixel matrix 102 and intended to be displayed by the group of pixels 104 coupled to the output 111.

Each group of pixels 104 includes a plurality of control circuits 110, each associated with a pixel block 106 of the group of pixels 104. Each of the control circuits 110 includes a primary memory circuit 126 (shown in FIG. 2) configured to store a portion of the digital data intended to be displayed by the associated pixel block 106. The control circuit also comprises electronic control elements which are configured, from the primary memory circuit 126, to send or distribute, to the pixels of the associated pixel block 106 the portion of digital data intended to be displayed by the pixel block 106. In the embodiment shown in FIG. 1, each group of pixels 104 includes 240 control circuits 110.

In the first embodiment described here, each group of pixels 104 is associated with a primary data distribution network 112, of the data bus type in this example, coupled to one of the outputs 111 of the video card 108 and to which each of the circuits 110 of the group of pixels 104 is coupled. In this configuration, each of the circuits 110 identifies the digital data to be displayed by the pixel block 106 with which the circuit 110 is associated via addressing of these data. In each group of pixels 104, the addresses of each circuit 110 have to be different from one another. In the example described here, because each group of pixels 104 includes 240 pixel blocks 106, the addresses of the circuits 110 may be defined as 8 bits. These addresses may be similar from one group of pixels 104 to another. For example, the circuit addresses 110 may be defined in hardware by conductor elements formed on the support on which the pixels are transferred, these conductor elements being connected either to the power supply (defining in this case a binary “1”) or to ground (defining in this case a binary “0”). The number of conductor elements used to define the address of each circuit 110 depends in particular on the number of circuits 110 to which an address has to be assigned within each group of pixels 104. By defining the addresses on the support, it is not necessary to encode these addresses within the control circuits 110, which allows the control circuits 110 to all be made identically.

FIG. 2 shows in more detail manner the primary data distribution network 112, two control circuits 110 and two pixels, with reference numerals 114 and 116, forming part of the block 106 with which one of the two circuits 110 is associated. Although only the two pixels 114, 116 are shown, the block 106 of the embodiment shown in FIG. 2 includes 64 pixels connected in series.

In the embodiment described here, the network 112 includes a first wire 118 on which digital data to be displayed is transmitted. The network 112 also includes a second wire 120 on which a primary clock signal generated by the video card 108 is transmitted. In the embodiment described here, the frequency of this primary clock signal is for example in the order of 40 MHz when the throughput of digital data sent to each group of pixels 104 is 36.9 Mbit/s. The network 112 also includes a third wire 122 on which a main display trigger signal is transmitted, the purpose of which is to trigger the display by the light elements of the pixels of data received by the pixels. Alternatively, the display of data received by the pixels may be triggered by a specific message transmitted on the first wire 118 of the network 112 and addressed to all the control circuits 110 via the use of a specific address dedicated to this display.

All the pixel blocks 106 forming part of a same group of pixels 104 are coupled to the same primary data distribution network 112, or in other words to a same data bus in this example. According to one embodiment, it is possible that at least one of the wires 120 and 122 is common to a plurality of primary data distribution networks 112, i.e. the same primary clock signal and/or same primary display trigger signal is sent to a plurality of pixel groups 104.

The circuit 110 includes a data receiving circuit 124 comprising inputs coupled to each of the wires 118, 120, 122 of the network 112. This circuit 124 performs the decoding of the address of the data transmitted over the network 112 and retrieves the data transiting on the wire 118 when the address of this data corresponds to that of the circuit 110. The retrieved data is stored in a primary memory circuit 126 of the circuit 110, the retrieved digital data corresponding to data to be displayed by the pixels of the associated block 106. Due to the fact that the circuit 110 identifies the digital data intended for the associated block 106 by means of an addressing system, the fact that the quantity of digital data intended for this block 106 is similar or not similar to that intended for other blocks 106 of the group of pixels 104, the order in which the data are transmitted and their possible cutting into a plurality of messages are not significant.

It should be noted that the primary memory circuit 126 does not form part of the data receiving circuit of the circuit 110 as such. The primary memory circuit 126 has the role of a buffer register, making it possible to decorrelate, dissociate the data receiving part of the bus 112 from the part described below, making it possible to send, distribute these data to the various pixels of the block.

Considering the above embodiment in which the digital data intended to be displayed for each image includes, for each pixel, 3 bytes (one byte for each colour to be displayed by each of the light elements of the pixel), the circuit 126 is capable of storing at least 192 bytes (64 pixels*3 bytes).

Each pixel includes here one or a plurality of secondary memory circuits 128 for storing the digital values to be displayed by the light element(s) (with reference numeral 130 in FIG. 2, and which correspond for example to LEDs or microLEDs) of said pixel. In the embodiment described here, each circuit 128 includes a shift register 132 of 8 bits coupled to a latch 134 (circuit “latch”). The registers 132 are coupled in series forming chain of registers within each pixel block 106, the output of a register associated with a pixel being connected to a next register in this same pixel or being connected to the input of a register of a “following” pixel. Alternatively, it is possible to have a single register common to the secondary memory circuits 128 of the same pixel, or in another embodiment, a plurality of register chains, for example each associated with a pixel colour. Other variants are also possible.

The secondary memory circuits 128 are coupled to a secondary data distribution network 152 assuring the data distribution from one of the control circuits 110 to the pixels of the pixel block 106 associated with said control circuit 110.

One of the registers 132 of one of the pixels of the block 106, forming the first pixel of the register chain of the block 106, is connected to the control circuit 110 by one of the wires of the secondary data distribution network 152 and receives successively as input the data stored in the memory circuit 126 of the circuit 110. At the rate of a clock signal clocking the serial movement of the data through the chain of registers, the data initially present in the memory circuit 126 are positioned in all of the registers of the chain. An amplifier 136, or buffer, may be present at the output of each pixel to ensure if necessary the maintenance of the amplitude level of the data transmitted from one pixel to the other. The registers 132 of all of the pixels of the block 106 receive as input a shift clock signal generated by the circuit 110, transmitted to the registers 132 by another wire of the network 152 and controlling the shift of data in the registers. Considering the embodiment described here, the frequency of the shift clock signal is greater than or equal to 153 kHz (to transmit 100 times per second 1536 bits). The shift clock signal may be generated by the control circuit 110 from the primary clock signal transmitted over the network 112. Lastly, the latches 134 of all of the pixels of the block 106 receive a storage trigger signal generated by the circuit 110, transmitted on another wire of the network 152 and which controls the storage, in the latches 134, of digital values present in the registers 132. This storage trigger signal is for example generated from the display trigger signal transmitted on the third wire 122, for example when the transmission of data in all the control circuits 110 is completed in the group of pixels.

Due to the fact that shift registers 132 are used within the pixels of the block 106, the quantity of digital data intended for each pixel is identical for all of the pixels of the block 106. Conversely, the use of a quantity of identical digital data for all the pixels of the block 106 allows the use of shift registers 132 within the pixels inexpensive in the surface of the semiconductor.

Each pixel also includes at least one drive circuit 138 configured to generate drive signals of the pixel light elements 130 from the digital data stored in the associated latch 134. When the light elements 130 correspond to LEDs, the driver circuit comprises for example a transistor placed in series with an LED between two power supply terminals; this transistor then being controlled by an “all or nothing” signal. In the embodiment described here, each circuit 138 comprises a PWM (pulse width modulation) modulator generating from the data present in the latch 134, an on-off PWM control signal of the transistor in series with the associated LED. Such a PWM control signal forms in a known way a signal alternating between two voltage levels which lead respectively to the conduction or the non-conduction of the transistor and consequently of the LED. The duration of the voltage level leading to the conduction of the LED is determined by the value to be displayed by the light element 130. Compared to a digital-to-analogue converter, a PWM modulator occupies a much smaller semiconductor area. Furthermore, it is possible to consider correcting possible technological dispersions between the LEDs or non-linearity problems of light elements, by adapting the digital values used for controlling the transistor in series with the LED.

It should be noted that the prior art includes various more or less complex “adjustment/control” circuits for the LED, the single transistor mentioned above being able to be associated with a cascode assembly or any other electronic device allowing the current flowing through the LED to be properly controlled.

The output of each circuit 138 is thus coupled to one of the light elements 130. The generation of the PWM control signal by the circuit 138 is driven by a control clock signal generated by the circuit 110 and transmitted to one of the wires of the network 152. The frequency of the control clock signal is selected to be sufficiently high to avoid flicker problems, and for example between 100 and 1000 times the image display frequency of the device 100, or even higher, such as for example equal to several MHz or several tens of MHz (the use of a high frequency has the advantage of reducing the need for precision with the frequency of this signal, but leads to a higher consumption of the circuit 138, a compromise having to be found). The control clock signal may be derived from the primary clock signal transmitted on the bus 112 or locally created.

As an alternative to the PWM modulator described above, it is possible that each circuit 138 corresponds to a BCM (binary code modulation) modulator. Details of such a modulation applied to the display of a pixel matrix are given in document EP3 550 550 A1.

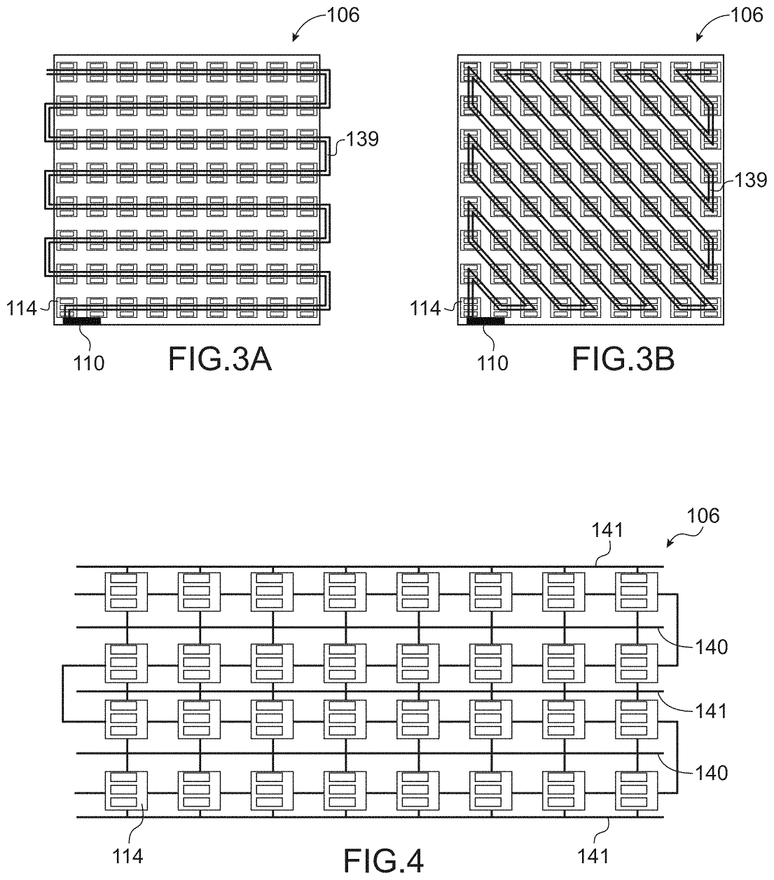

Within each pixel block 106, the shift registers 132 of the different pixels may be connected in series by wires of the network 152 in different ways: row by row, column by column, in a serpentine manner, etc. Two examples of the series connection between the pixel shift registers 132 of a pixel block 106 (arranged as an 8×8 pixel block) are shown in FIGS. 3A and 3B. In these figures, the reference numeral 139 denotes the network connection 152 via which the digital data passes through each of the shift registers 132. The order in which the digital data are sent within each pixel block 106 takes into account the connection of the pixels within the pixel block 106.

In the embodiment described above, all the pixels are identical, which facilitates their manufacture and transfer to the screen substrate.

For the formation of the device 100, it is possible that the pixels are arranged on a front face of the support of the device 110, and that the circuits 110 are transferred onto a rear face of the support. The different wires of the device 100 described above may be formed on the front face and/or the rear face of the support. Furthermore, the addresses of the circuits 110 may be defined by engraving on the support, corresponding for example to a printed circuit board, including electrical interconnection rows. Furthermore, in the device 100, the different wires connected to the pixels may be distributed over the front and rear faces of the support, or even in a plurality of routing levels formed in and on the support.

Alternatively to the embodiment described above, each block 106 may correspond to a block of 16×16 pixels, which ultimately makes it possible to reduce the number of circuits 110 in the device 100. More generally, the number of pixels in each block 106 may be determined as a function of the desired throughputs on the various connection rows, the available processing times, etc. These parameters may be taken into account when designing the device 100 to determine the number of pixel groups 104 and pixel blocks 106 of the device 100.

In addition to the signals described above, the pixels are also each connected to a power supply row and a reference electrical potential row. FIG. 4 shows an example of a configuration of pixels within a block 106, wherein at least some of the power supply rows 141 and ground rows 140 are shared between two neighbouring rows of pixels. Decoupling capacitors, not shown in FIG. 4, may also be provided to filter and stabilise the power supply to the pixels which may be noisy due to the current draws on the access resistors, in particular those related to the length of the power supply rows. The routing of the power supply rows 141 and the ground rows 140 may be performed with an interconnection layer, or a plurality of layers (for example one layer for the power supply and another for the grounding to reduce access resistance, by integrating the use of vias).

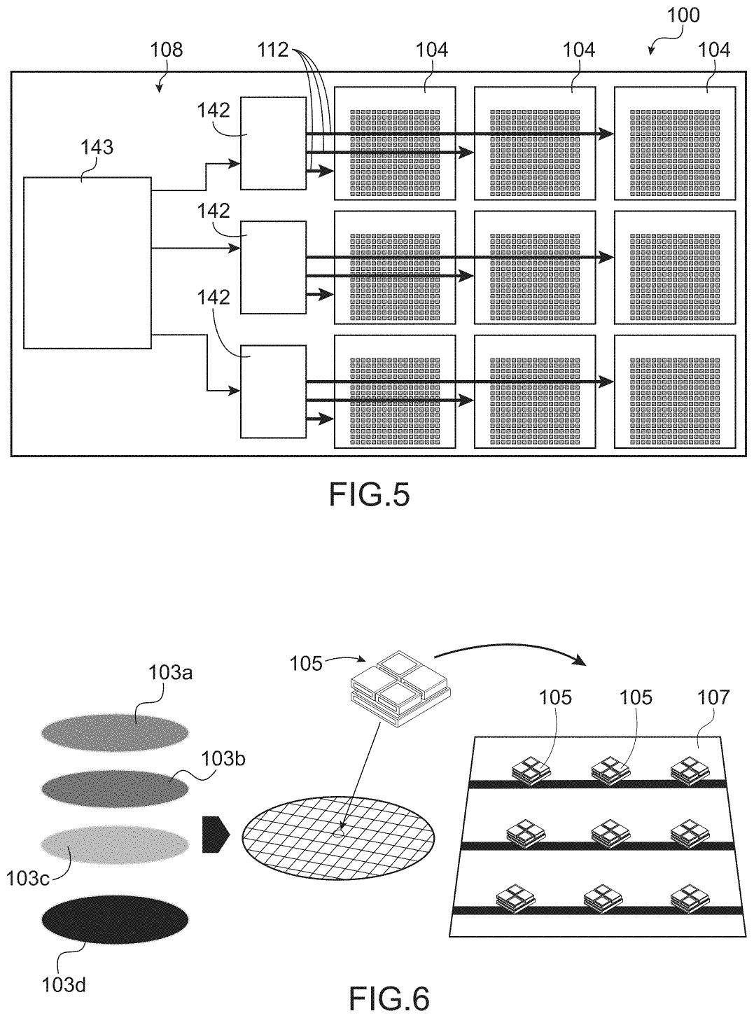

In the first embodiment described above, the pixel groups 104 correspond to pixels distributed over eight rows of pixels. Alternatively, the groups 104 of pixels may be different. For example, the pixels in the same row of the matrix 102 may be distributed in a plurality of distinct pixel groups 104, as is the case in the schematic example of FIG. 5. In the example of FIG. 5, each group of pixels 104 corresponds to a “macropixel”, each macropixel corresponding to a pixel matrix of 8*35 by 8*40 pixels (equivalent to 35*40 pixel groups of 8*8), the matrix 102 thus having a matrix of 3 by 3 macropixels.

Furthermore, in FIG. 5 the video card 108 includes a primary circuit 143 performing the functions previously described for the video card 108, and driver circuits 142 interposed between the primary circuit 143 and the networks 112 and ensuring the distribution of the digital data to be displayed to different pixel groups 104. The device 100 includes such driver circuits 142 in particular when the number of pixel groups 104 is too large for the number of outputs of the primary circuit 143 of the video card 108 to be equal to the number of pixel groups 104.

In the previously described embodiment, the control circuits 110 are made in the form of electronic chips distinct from the pixels. Alternatively, it is possible that each circuit 110 is formed within the first pixel of each block 106, i.e. the pixel which is directly connected to the circuit 110.

In the embodiment described above, the number of bits of the digital data to be displayed by each light element 130 is equal to 8. This number of bits may be different, and for example equal to 10.

In the embodiment described above, the control clock signal and the shift clock signal are distinct and both sent to the input of each pixel.

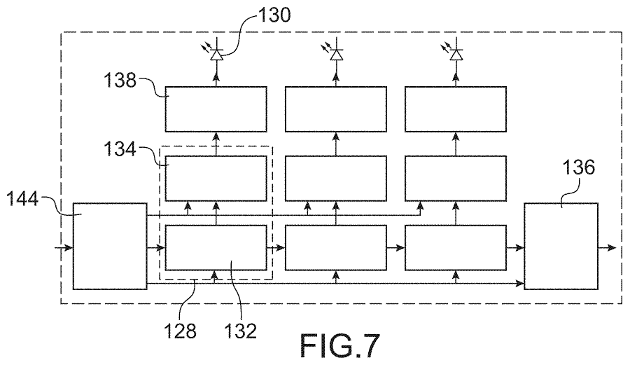

In the first embodiment described above, each secondary memory circuit 128 includes a shift register 132 coupled to a latch 134, and each driver circuit 138 includes a PWM or BCM modulator. According to one variant, each driver circuit 138 may include, instead of the PWM or BCM modulator, a digital-to-analogue converter outputting an analogue signal driving the light emission of one of the light elements 130. Each digital-analogue converter converts the digital data to be displayed stored in one of the latches 134 into a current supplied to the light element 130 and the value of which is determined for example according to a conversion curve adapted to the characteristics of the light element 130. Compared to a PWM or BCM modulator, such a digital-analogue converter has the disadvantage of being more cumbersome. FIG. 7 shows such a variant.

Furthermore, in the configuration shown in FIG. 2, each pixel receives as input the data signal, the shift clock signal controlling the shift registers 132, the control clock signal for the PWM or BCM modulators, and the storage trigger signal controlling the latches 134.

In the configuration shown in FIG. 7, when the analogue-digital converters are asynchronous, each pixel may only receive a single signal via the network 152. In this single signal, the data may be encoded using the pulse duration such that:
high state of short duration (for example one third of the period) encodes a bit in a first state (for example “0”);
a high state of long duration (for example two thirds of the period) encodes a bit in a second state (for example “1”);
a low state for the entire period corresponds to a reset, controlling the display of the data located in the registers 132.

In this configuration, each pixel includes a circuit 144 which generates from the single signal received, a digital data signal sent to the input of a first shift register 132 (the registers 132 of the pixel are connected in series, as in the preceding examples), a shift clock signal controlling the shift registers 132, and a storage trigger signal controlling the storage, in latches 134, of the data value in the registers 132. Using the coding example described above, the bit values of the digital data generated by the circuit 144 are a function of the duration of each high state detected in the signal received at the input of the circuit 144. The storage in the latches 134 is triggered when a reset is detected in the signal received as input to the circuit 144.

This configuration has the advantage of limiting the number of wires connected to the input and output of the pixels, i.e. the number of wires in the secondary data distribution network 152, thereby facilitating the implementation of the device 100.

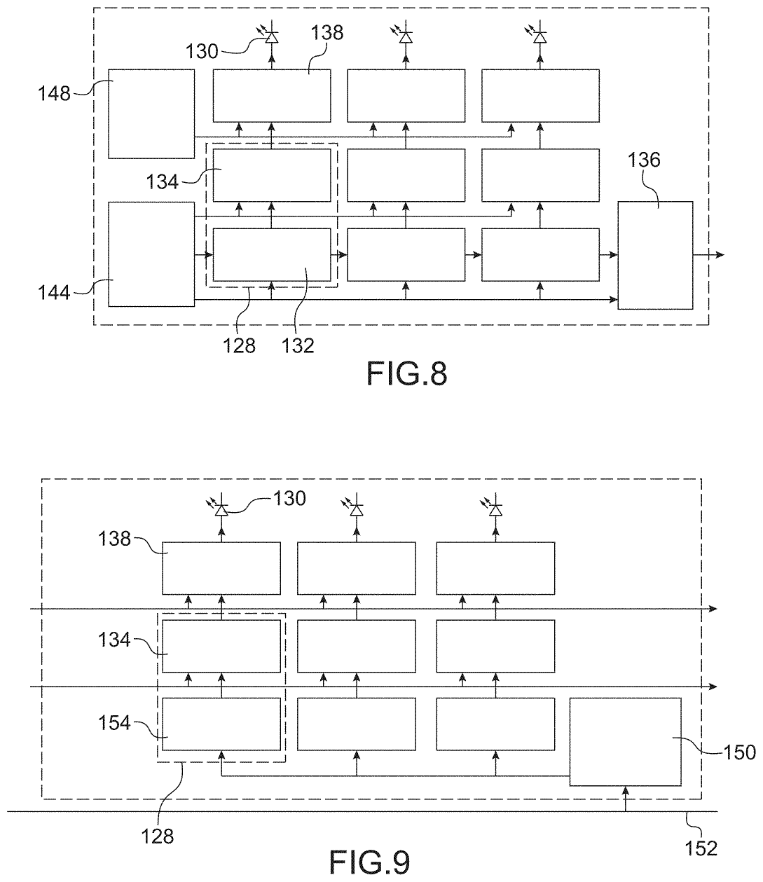

The FIG. 8 shows another embodiment variant of pixels of the device 100. In this other variant, each pixel includes all of the elements of the pixel shown in FIG. 7, except for the circuit 138 which includes a PWM or BCM modulator in place of the digital-to-analogue converter. In this variant, given that the pixel does not receive the control clock signal as input, this control clock signal is generated locally within each pixel by a circuit 148.

Compared to digital-to-analogue converters, PWM or BCM modulators have the advantage of being less cumbersome and of controlling the display elements with digital signals only, which facilitates the control of the light intensity of the light elements 130.

In the configurations described above, the data are transmitted on separate wires from those used for the electrical power supply. Alternatively, it is possible that data are transmitted by being modulated into electrical power supply signals. In this case, an additional demodulation step is implemented in the pixels. Details of such an embodiment are explained in document EP3 649 672 A1 and may be applied by analogy to the present device.

In addition to the elements dedicated to displaying digital data, the device 100 may include elements for managing transmission errors (parity code, error correction, signalling bits, etc.) and control circuits 110 may include associated digital processing. An acknowledgement wire, or link may possible be provided in the network 112 so that each control circuit 110 may communicate with the video card 108 the good or poor reception of data and request possible data resending if necessary.

In the first embodiment described above as well as in its various embodiment variants, the secondary memory circuits 128 are, in each pixel block 106, connected in series to one another.

In a second embodiment, each pixel includes a secondary address decoding circuit 150 capable of identifying the digital data to be displayed by the pixel. In each pixel block 106, the inputs of the circuits 150 of the pixels of the block 106 are coupled to the secondary data distribution network associated with this pixel block 106, the distribution network being for example of the data bus type.

The FIG. 9 shows an embodiment of a pixel of the device 100 according to this second embodiment. In this embodiment, each secondary memory circuit 128 of the pixel includes a register 154 comprising an input coupled to an output of the circuit 150 and the latch 134 whose input is coupled to the output of the register 154.

In this second embodiment, the digital data are no longer distributed in series through the shift registers 132, but are transmitted to all the circuits 150 of the block 106 via the secondary data distribution network 152. In addition, each pixel has its own address. This address may be encoded in a non-volatile memory of each circuit 150, or physically on the substrate as described above for the addresses of the control circuits 110. With this second embodiment, the amount of digital data intended for each pixel of the block 106 may be different from one pixel to another and possibly split into several packets.

The different embodiments previously described for the first embodiment may be applied to this second embodiment.

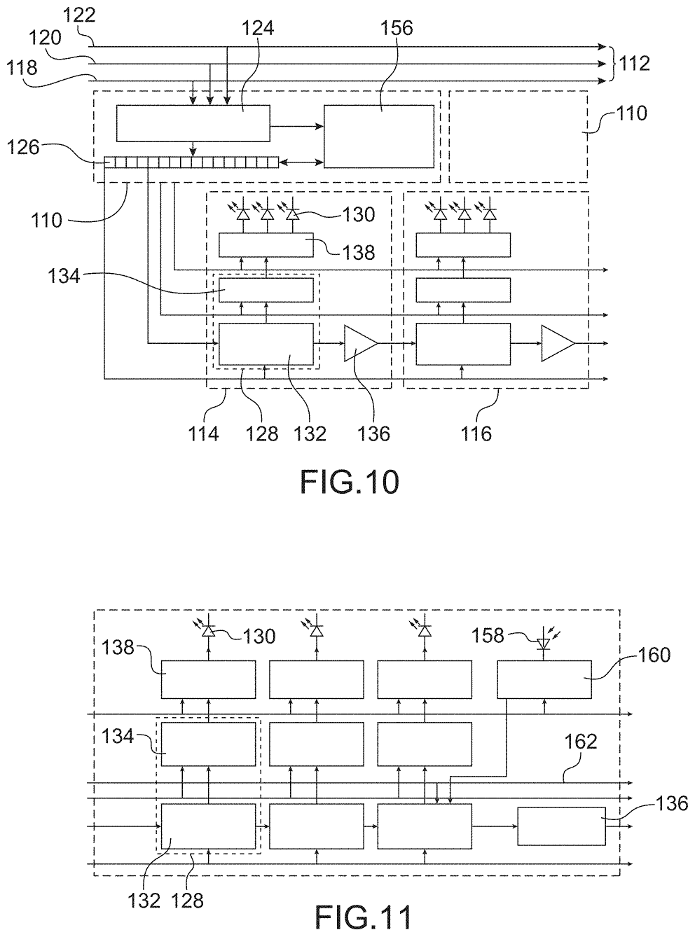

In all the embodiments and variants, the control circuits 110 and/or the video card 108 may carry out in addition to sending digital data to be displayed and clock signals to each group of pixels 104 and/or pixel block 106, one or more digital processes of the data to be displayed before they are sent to the pixel groups 104 and/or pixel blocks 106. This digital processing of data may correspond for example to a correction of luminosity, a gamma correction according to a colour correction curve for the entire matrix 102, or a calibration of pixels. All of these correction possibilities may be translated into an adjustment of the control signals for the emission level of the light elements. FIG. 10 schematically shows a circuit 110 including a circuit 156 which includes a memory for storing, permanently or non-permanently, digital information useful for the implementation of one or more digital processes of the data to be displayed. In the same manner, when one or more of these digital processes is carried out by the video card 108, the latter then includes an electronic circuit for implementing this or these digital processes. Furthermore, one or more of these digital processes may also be carried out directly in each pixel, by adding in this case a data processing circuit for example in the portion forming the memory and calculation circuits 128, 138 of each pixel.

In all of the embodiments and variants described above, it is possible that each pixel, or at least a portion des pixels, include at least one sensor. FIG. 11 schematically shows an embodiment example of such a pixel.

This pixel includes, in addition to the elements described above in relation to FIG. 2, a photodetector 158 corresponding for example to a photodiode, and an analogue-to-digital converter 160. The signal outputted by the photodetector 158 is sent to the input of the analogue-to-digital converter 160. The choice of the number of bits that may be converted by the converter 160 depends in particular on the desired resolution and also on the space available in the pixel. For example, the converter 160 may be capable of converting 8 bits or 4 bits, or even 1 bit (the converter 160 forming a comparator in this case).

For its timing, the converter 160 receives as input, in the example of FIG. 11, the same clock signal as the one applied to the input of the PWM modulators, namely the control clock signal. The output of the converter 160 is coupled to an input of one of the pixel registers 132. This register 132 receives as input a loading signal sent from the control circuit 110, by means of a wire 162 of the network 152 dedicated to this signal, for example when receiving a command to read the photodetectors 158.

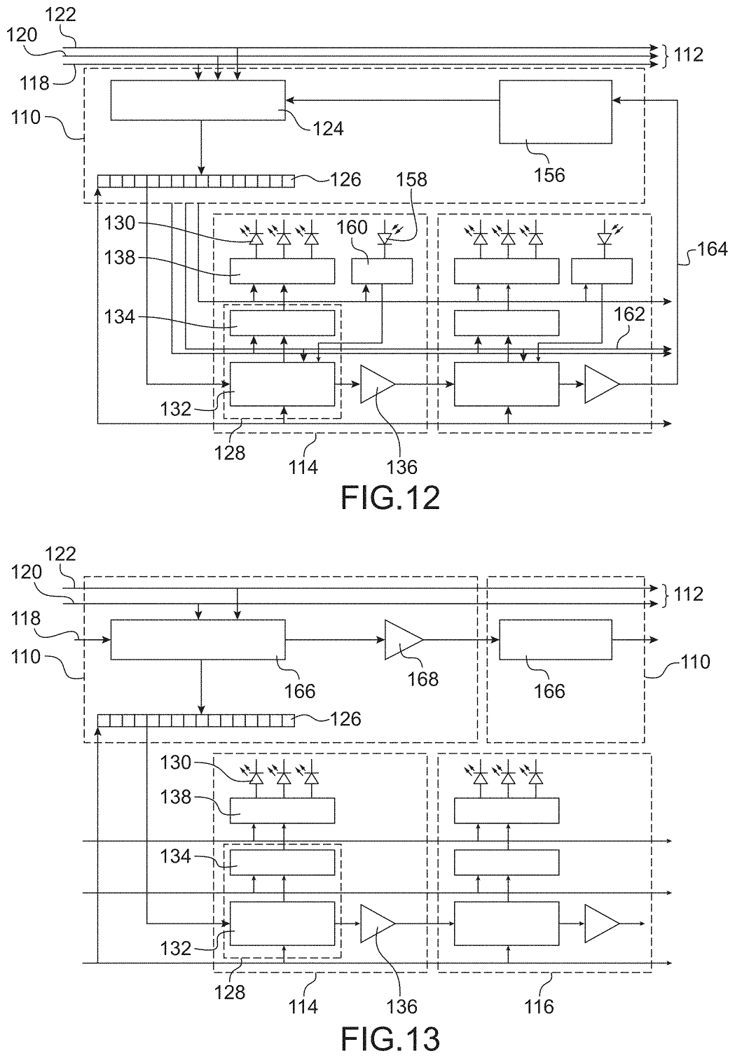

In an advantageous manner, in order to facilitate the recovery of the photodetection data, the wire used for the transmission of the digital data signal to be displayed is looped back from the output of the last register 132 of the pixel block 106 to an input of the circuit 110 associated with the pixel block 106. This loopback is represented in FIG. 12 by a wire 164 running from the output buffer of the last pixel of the pixel block 106 to the circuit 110 associated with this pixel block 106.

The photodetection data retrieved from the control circuits 110 may then be digitally preprocessed in the control circuits 110, for example to perform motion detection by locally storing the data acquired at the previous time, making differences with the data just acquired, and transmitting only the relevant data, for example changes, thereby reducing the amount of data to be sent out and then processed.

In the first and second embodiments described above, in each group of pixels 104, the control circuits 110 are coupled to a primary data distribution network 112 and each circuit 110 includes a data receiving circuit 124 enabling it to identify the digital data to be displayed by the pixel block 106 to which it is associated and to send this data to the pixels in the block 106. Alternatively, it is possible that in each group of pixels 104, the control circuits 110 include a data receiving circuit different than the one above, and comprising at least one shift register 166 coupled in series with shift registers of other control circuits 110 of the group of pixels 104. Such a configuration is schematically shown in FIG. 13. The output of the shift register 166 of a control circuit 110 is coupled to the input of the shift register 166 of the control circuit 110 through an amplifier 168.

In all of the embodiments, the different connections formed by the electrical wires may be replaced by optical or RF connections.

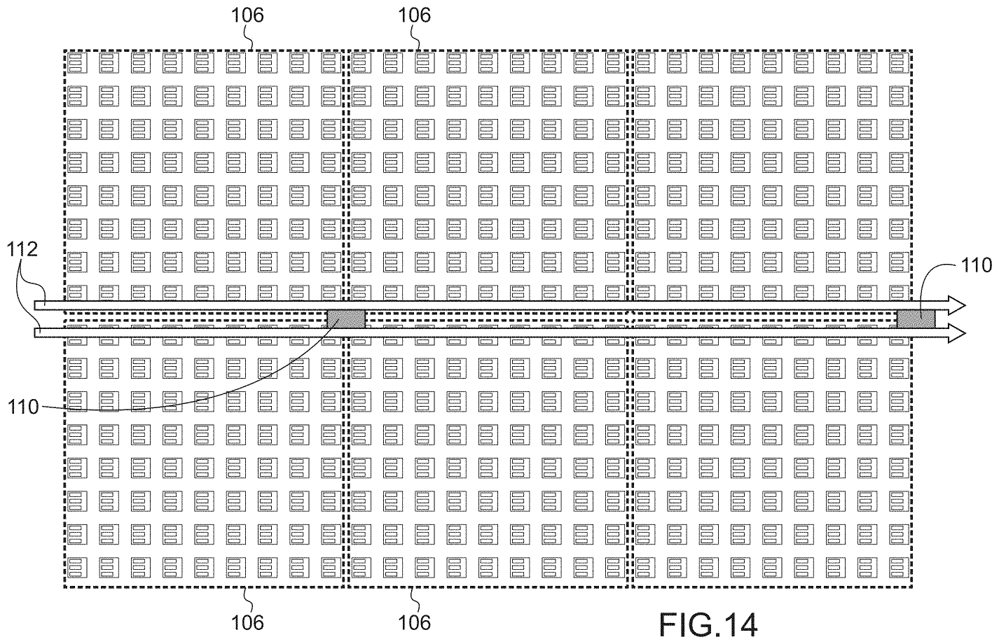

In the various embodiments described above, each control circuit 110 is associated with a pixel block 106. Alternatively, it is possible that a single integrated circuit, referred to as a “macro control circuit” 180, comprises a plurality of control circuits 110 associated with a plurality of pixel blocks 106. Such a variant is shown for example in FIG. 14, in which each “macro” control circuit 180 is associated with four pixel blocks 106. Furthermore, in the configuration of the FIG. 14, each macro control circuit 180 is split between two rows of pixel blocks 106, or in other words two groups of pixels, and the macro control circuit 180 is coupled to two primary data distribution networks 112 on which data for the pixel blocks 106 coupled to the macro control circuit 180 is sent. Such a configuration has the advantage of reducing the number of chips to be transferred from the display device 100 (4 times fewer chips for the example in FIG. 14). Various organisations are possible, for example four control circuits 110 being grouped together on the same silicon chip, and possibly splitting the calculation or memory blocks to carry out data processing for example.

In all of the previously described embodiments and examples, it is possible that the supply voltages transmitted to the light elements 130 have a value higher than that with which the light elements 130 are intended to function. For a given value of power to be transmitted to the light elements 130, this makes it possible to transmit this power with a lower current, which will ultimately make it possible to reduce drops in voltage, and therefore losses related to access resistances. In such a configuration, the device 100 includes voltage reduction circuits 182 interposed between the electric power supply source of the device 100 and the light elements 130 and which make it possible to adjust the value of the voltage received to that desired for the operation of the light elements 130.

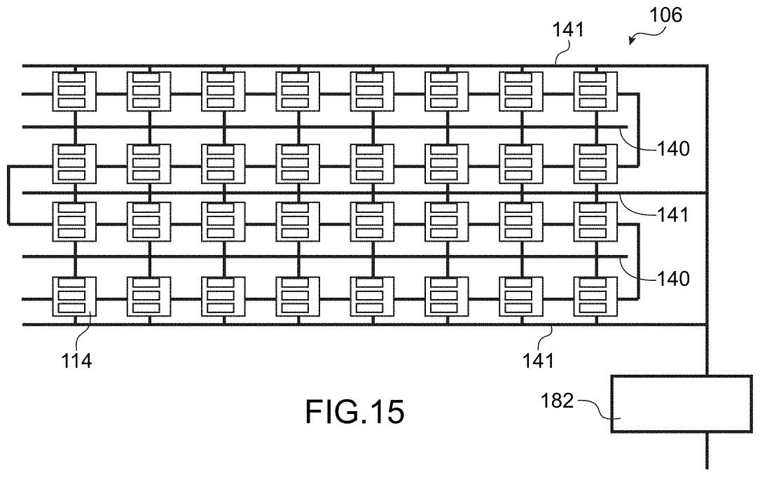

FIG. 15 schematically shows a portion of a pixel block 106 wherein the power supply rows 141 receive a voltage which has been lowered by a voltage reduction circuit 182.

In an advantageous manner, the voltage reduction circuits 182 may be integrated into the control circuits 110 or the macro control circuits, so that the number of chips to be transferred to the carried does not need to be increased.

1. A display device including at least:
one pixel matrix comprising a plurality of pixel groups, each group of pixels comprising a plurality of pixel blocks, each including a plurality of pixels distributed over a plurality of adjacent rows of pixels and over a plurality of adjacent columns of pixels, and each pixel comprising at least one light element;
a video card comprising at least one input configured to receive a digital signal to be displayed by the pixel matrix, and a plurality of outputs, each coupled to a group of pixels by an associated primary data distribution network, the video card being configured to decode the digital signal and send to each of the outputs digital data encoded in a format suitable for the pixel matrix and intended to be displayed by the group of pixels coupled to said output;
and wherein:
each group of pixels includes a plurality of control circuits each associated with pixel block of the group of pixels and coupled to the associated primary data distribution network, each control circuit including a primary memory circuit configured to store a portion of the digital data intended to be displayed by the associated pixel block and being configured to send to the associated pixel block, via an associated secondary data distribution network, said portion of the digital data intended to be displayed by the associated pixel block;
each pixel includes at least one driver circuit configured to generate control signals of the one or more light elements of the pixel from the digital data intended to be displayed by the one or more light elements of the pixel.

2. The display device according to claim 1, wherein each pixel corresponds to a module distinct from the other pixels and carried on a support of the pixel matrix on which all or part of the primary data distribution networks and the control circuits are located.

3. The display device according to claim 1, wherein each control circuit includes at least one data receiving circuit configured to identify the portion of the digital data intended to be displayed by the pixel block with which the control circuit is associated, by means of an address associated with the data receiving circuit, on the associated primary data distribution network comprising a data bus.

4. The display device according to claim 1, wherein, in each group of pixels, the control circuits include primary shift registers coupled in series from one control circuit to the other and separate from the primary memory circuits, the primary shift register of a control circuit being configured to receive, on the primary data distribution network, the portion of digital data to be displayed by the pixel block with which the control circuit is associated.

5. The display device according to claim 1, wherein each pixel further includes a secondary memory circuit coupled to the associated secondary data distribution network, the secondary memory circuit being configured to store the digital data intended to be displayed by the light element(s) of the pixel, the driver circuit of the pixel comprising an input coupled to an output of the secondary memory circuit of the pixel and at least one output coupled to the light element(s) of the pixel.

6. The display device according to claim 5, wherein, in each pixel block, the secondary memory circuits include secondary shift registers coupled in series from one pixel to another and configured to pass digital data to be displayed by the pixels of a single block from one pixel to another.

7. The display device according to claim 6, wherein, in each pixel, each secondary memory circuit further includes a latch comprising at least one input coupled to an output of the secondary shift register of the secondary memory circuit, and at least one output coupled to the input of the driver circuit of the pixel.

8. The display device according to claim 5, wherein:
each pixel includes at least one secondary address decoding circuit coupled to the associated secondary data distribution network, the secondary address decoding circuit being capable of identifying digital data intended to be displayed by the pixel;
each pixel block includes at least one secondary data link of the data bus type to which at least one input of the secondary address decoding circuit of each pixel of the pixel block is coupled.

9. The display device according to claim 8, wherein each secondary memory circuit includes:
at least one register comprising at least one input coupled to an output of the secondary address decoding circuit of the pixel comprising the secondary memory circuit, and
at least one latch comprising at least one input coupled to an output of the register of the secondary memory circuit, an output of the latch being coupled to an input of the circuit for driving the pixel comprising the secondary memory circuit.

10. The display device according to claim 1, further including voltage reduction circuits configured to electrically power the pixels.

11. The display device according to claim 1, wherein the driver circuits include PWM or BCM modulators or numerical-analogue converters.

12. The display device according to claim 1, wherein each control circuit is formed by a chip separate from the pixels of the pixel block with which the control circuit is associated, or wherein each control circuit is integrated into one of the pixels of the pixel block with which the control circuit is associated.

13. The display device according to claim 1, wherein the video card and/or the control circuits and/or the pixels include at least one digital data processing circuit.

14. The display device according to claim 1, wherein at least a portion of the pixels each include at least one photodetector coupled to an analogue-to-digital converter.

15. The display device according to claim 6, wherein:
at least a portion of the pixels each include at least one photodetector coupled to an analogue-to-digital converter;
in each pixel, an output of the analogue-to-digital converter is coupled to an input of the shift register of the pixel;
in each block of pixels, an output of the shift register of one of the pixels of the pixel block is coupled electrically to an input of the control circuit associated with the pixel block.
